(19) United States
(12) Patent Application Publication
(10) Pub. No.: US 2024/0126367 A1
(43) Pub. Date: Apr. 18, 2024

(54) INDIRECT TIME OF FLIGHT (TOF) DEPTH SENSING FOR EYE TRACKING

(71) Applicant: Meta Platforms Technologies, LLC, Menlo Park, CA (US)

(72) Inventors: Gaetano AIELLO, Redmond, WA (US); Yatong AN, Redmond, WA (US); Youmin Wang, Bellevue, WA (US)

(73) Assignee: Meta Platforms Technologies, LLC, Menlo Park, CA (US)

(21) Appl. No.: 18/359,585

(22) Filed: Jul. 26, 2023

Related U.S. Application Data
(60) Provisional application No. 63/415,775, filed on Oct. 13, 2022.

(51) Int. Cl. G06F 3/01; G01S 7/481; G01S 7/4915; G01S 17/32

(52) U.S. Cl. CPC G06F 3/013; G01S 7/4814; G01S 7/4915; G01S 17/32

(57) ABSTRACT

An eye tracking system employing three-dimensional (3D) sensing using time of flight is provided. Instead of directly measuring the time of arrival of the emitted photons, the light intensity of the transmitted laser beam is modulated, and a phase change of the return beam computed by comparison with the transmit waveform. The modulation frequency is resolved with radio frequency (RF) mixing and digital signal processing techniques. A variety of phase detection systems and techniques including, but not limited to, quadrature analog front end detection and analog homodyne phase detection are applied. The modulation frequency may, depending on phase detection technique, be sinusoidal or pulsed.

### PRIORITY

This patent application claims priority to U.S. Provisional Patent Application No. 63/415,775, entitled “INDIRECT TIME OF FLIGHT (TOF) DEPTH SENSING FOR EYE TRACKING,” filed on Oct. 13, 2022.

### TECHNICAL FIELD

This patent application relates generally to eye tracking in near-eye display devices, and in particular, to three-dimensional (3D) sensing for eye tracking using time of flight (TOF) information through modulation of light intensity in a transmitted laser beam.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIGS. 3A and 3B illustrate a perspective view and a top view of a near-eye display in the form of a pair of glasses, according to an example.

FIG. 4A illustrates a comparison of three-dimensional (3D) sensing for eye tracking using direct and indirect time of flight (TOF) information.

FIG. 4B illustrates a diagram of phase shift in indirect time of flight (TOF) detection, according to an example.

FIG. 5A illustrates a schematic diagram of a device for quadrature analog front end detection, according to an example.

FIG. 5B illustrates waveform diagram for continuous wave quadrature detection.

FIG. 6 illustrates a system diagram for analog homodyne phase detection, according to an example.

FIG. 7 illustrates a flow diagram of a method for three-dimensional (3D) sensing for eye tracking using indirect time of flight (TOF) information, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Tracking a position and orientation of the eye as well as gaze direction in head-mounted display (HMD) devices may unlock display and rendering architectures that can substantially alleviate the power and computational requirements to render 3D environments. Furthermore, eye-tracking enabled gaze prediction and intent inference can enable intuitive and immersive user experiences adaptive to the user requirements in his/her interaction with the virtual environment.

Eye tracking systems may be classified into two main categories: scanning based and camera based. Camera based systems may be limited in their speed (image rate <500 frames per second (fps)). Moreover, camera based systems rely on illumination of multiple light emitting diodes (LEDs) or similar sources, which adds to the total system's power consumption. On the other hand, scanning based eye tracking provides fast scanning speed, dynamic laser intensity control, and smaller profile (size, weight, and power). However, laser scanning based systems only collect spectral and diffuse scattering light intensity information from the eye, which still cannot guarantee high tracking accuracy and precision. Additional information may be needed to be extracted from the laser scanning imaging so as to enhance the overall scanning based imaging performance.

In some examples of the present disclosure, an eye tracking system employing three-dimensional (3D) sensing using time of flight. Instead of directly measuring the time of arrival of the emitted photons, the light intensity of the transmitted laser beam may be modulated, and a phase change of the return beam computed by comparison with the transmit waveform. For example, for a three-dimensional (3D) profile of the eye with a feature size of 2 mm, corresponding to an induced phase change in the reflected beam of 0.08 rad or 4.6 deg, a 2 GHz modulation frequency may be sufficient for the transmitted laser beam. The modulation frequency may be easily resolved with radio frequency (RF) mixing and digital signal processing techniques. A variety of phase detection systems and techniques may be applied. Non-limiting examples may include quadrature analog front end detection and analog homodyne phase detection. The modulation frequency may, depending on phase detection technique, be sinusoidal or pulsed.

While some advantages and benefits of the present disclosure are apparent, other advantages and benefits may include increased accuracy of eye tracking while a weight, power consumption, and size of components associated with eye tracking are reduced, specifically in near-eye display devices.

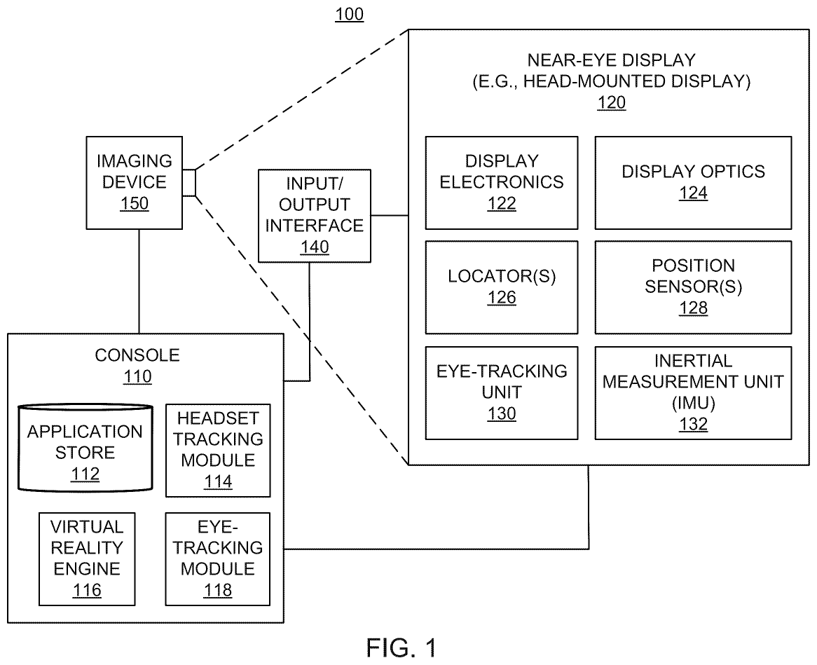

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.” As used herein “time of flight (ToF)” refers to a measurement of the time taken by a particle or wave (e.g., a photon or a light wave) to travel a distance through a medium (e.g., air).

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

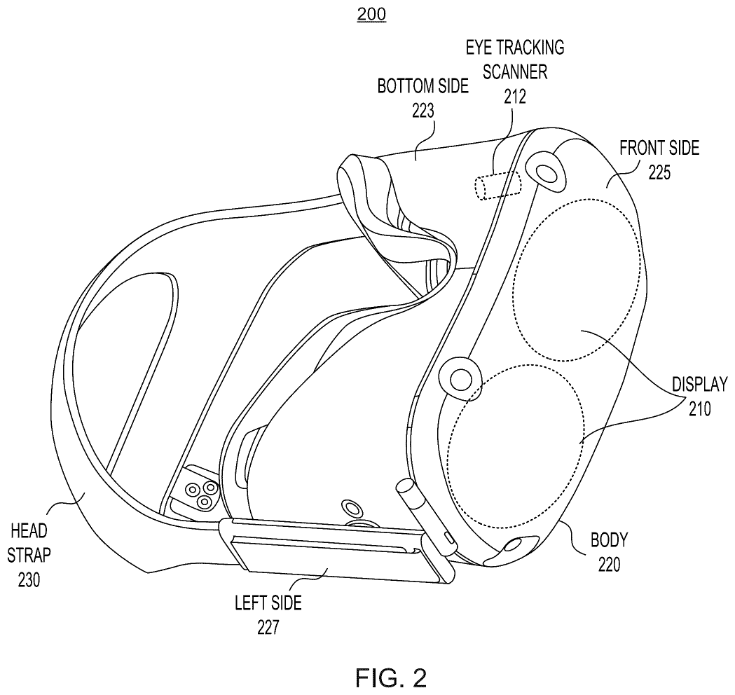

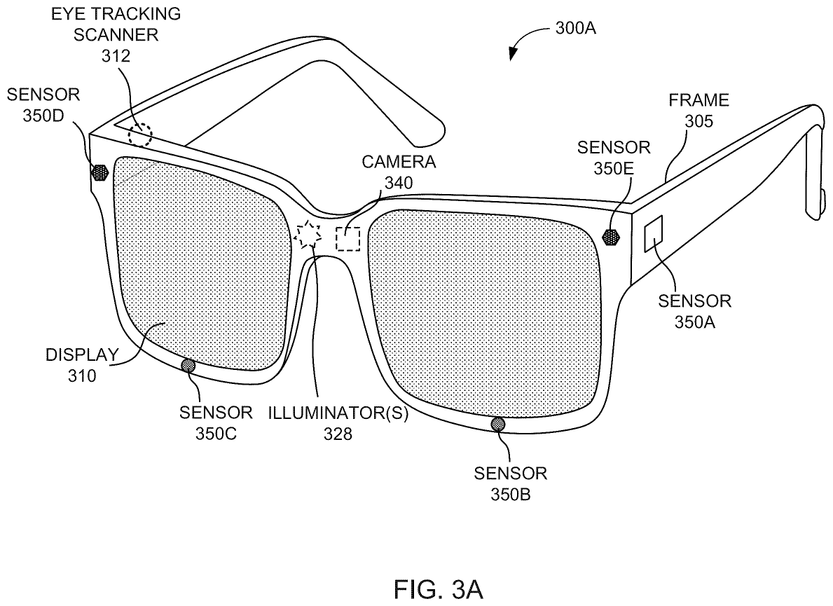

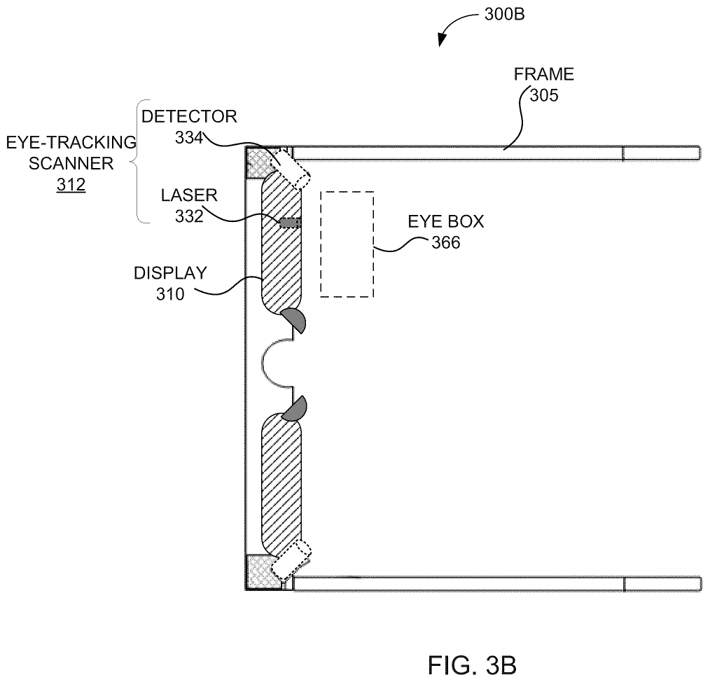

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera). In other examples, the eye tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, the eye tracking module 118, which may be implemented as a processor, may receive eye tracking data from the eye tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the head-mounted device (HMD) device 200 may be a part of a virtual reality (VR) system, an augmented reality (AR) system, a mixed reality (MR) system, another system that uses displays or wearables, or any combination thereof. In some examples, the head-mounted display (HMD) device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components.

In some examples, the head-mounted display (HMD) device 200 may present, to a user, media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the head-mounted display (HMD) device 200.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface 140 for communicating with a console 110, as described with respect to FIG. 1. In some examples, the head-mounted display (HMD) device 200 may include a virtual reality engine (not shown), but similar to the virtual reality engine 116 described with respect to FIG. 1, that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine 116 may be used for producing a signal (e.g., display instructions) to the one or more display assemblies. In some examples, the head-mounted display (HMD) device 200 may include locators (not shown), but similar to the virtual locators 126 described in FIG. 1, which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, an eye tracking scanner 212 in conjunction with a laser source may be used to detect three-dimensional (3D) features of the eye to track a gaze of the user. The eye tracking scanner 212 or a communicatively coupled processor (e.g., eye tracking module 118 in FIG. 1) may analyze reflected laser light and determine a phase change to compute time of flight (TOF).

FIG. 3A is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 210 may include a projector, or in place of the display 310 the near-eye display 300 may include a projector.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar applications.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications. The near-eye display 300 may also include an eye tracking scanner 312.

FIG. 3B is a top view of a near-eye display 300 in the form of a pair of glasses (or other similar eyewear), according to an example. In some examples, the near-eye display 300 may include a frame 305 having a form factor of a pair of eyeglasses. The frame 305 supports, for each eye: an eye tracking scanner 312, which may include a laser source 332 and a detector 334, a display 310 to present content to an eye box 366, and one or more illuminators 330. The illuminators 330 may be used for illuminating an eye box 366. The laser source 332 may transmit a modulated laser beam to the eye. The detector 334 may capture a reflected beam. A phase difference between the transmitted beam and the reflected beam may be determined to compute time of flight (TOF). The display 310 may include a pupil-replicating waveguide to receive the fan of light beams and provide multiple laterally offset parallel copies of each beam of the fan of light beams, thereby extending a projected image over the eye box 366.

In some examples, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view.

The eye tracking scanner 312 may be used to determine position and/or orientation of both eyes of the user. Once the position and orientation of the user's eyes are known, a gaze convergence distance and direction may be determined. The imagery displayed by the display 310 may be adjusted dynamically to account for the user's gaze, for a better fidelity of immersion of the user into the displayed augmented reality scenery, and/or to provide specific functions of interaction with the augmented reality. In operation, the illuminators 330 may illuminate the eyes at the corresponding eye boxes 366, to enable the eye tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 366.

In some examples, the image processing and eye position/orientation determination functions may be performed by a central controller, not shown, of the near-eye display 300. The central controller may also provide control signals to the display 310 to generate the images to be displayed to the user, depending on the determined eye positions, eye orientations, gaze directions, eyes vergence, etc.

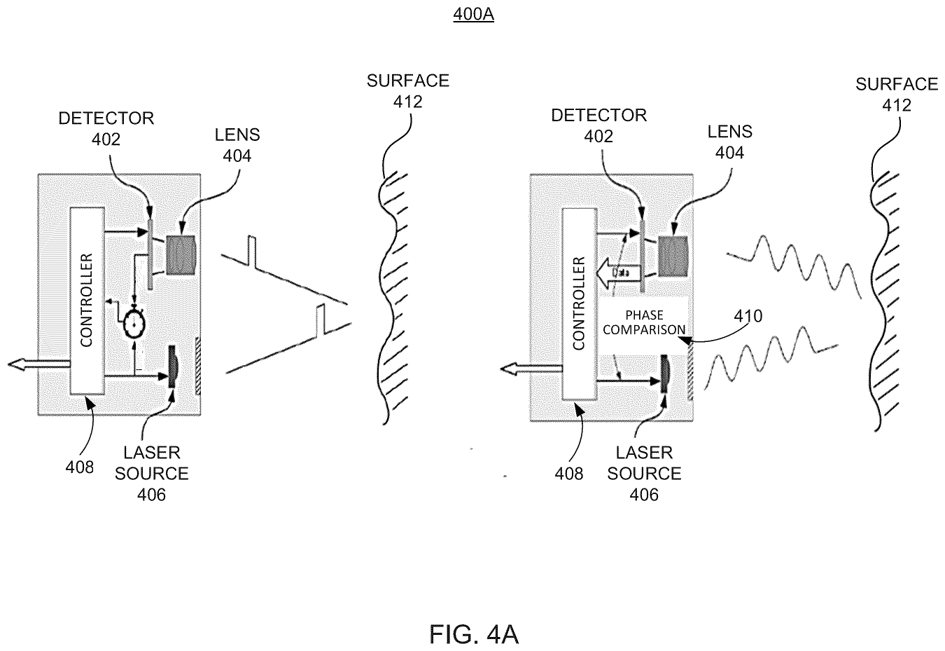

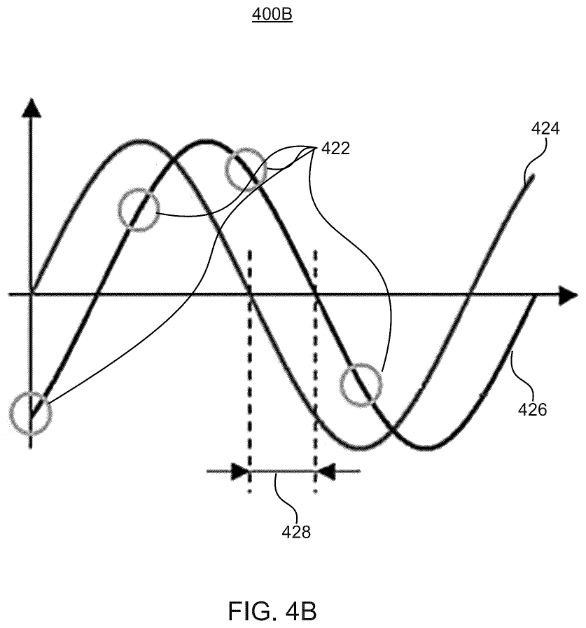

FIG. 4A illustrates a comparison of three-dimensional (3D) sensing for eye tracking using direct and indirect time of flight (TOF) information. Diagram 400A shows an eye tracking scanner that includes a laser source 406 transmitting a laser beam to surface 412, a lens 404 to focus received laser beam (reflected), detector 402, and a controller 408. In direct time of flight (TOF) detection, the laser source 406 transmits a pulse to the surface 412, and the controller determines a time difference between the transmitted pulse and the received pulse and computes the time of flight (TOF) based on a time difference between the transmitted pulse and the received pulse. In indirect time of flight (TOF), the laser source 406 transmits a modulated laser beam to the surface 412. The controller 408 determines a phase difference between the transmitted pulse and the received pulse and computes the time of flight (TOF) based on a phase difference between the transmitted pulse and the received pulse. The time of flight (TOF) may then be used to identify three-dimensional (3D) features on the surface 412.

Photons in a laser beam carry a variety of information such as intensity, wavelength, propagation phase, etc. Other than using intensity only based imaging method to extract the reflectivity information from the eye, time of flight (TOF) information may be leveraged to extract a three-dimensional (3D) profile of the eye, thereby enhancing a detection efficiency of the eye. A challenge with time of flight (TOF) approach is propagation speed of light.

A range for direct time of flight (TOF) systems may be expressed as:

d=c*Δτ/2 (1)

A resolution may be expressed as:

Δτ=2Δd/c (2)

For example, when a laser transmitter and detector are mounted on augmented reality/virtual reality (AR/VR) glasses about 3 cm away from the eye, the roundtrip time of the light travel is only about 0.05 ns. To resolve the time arrival distance resolution down to 1 mm, a time domain detection resolution of about 7 ps may be needed. Thus, a digitizer with higher than 100 GHz capability may be needed making the solution impractical.

FIG. 4B illustrates a diagram of phase shift in indirect time of flight (TOF) detection, according to an example. Diagram 400B shows modulation patterns 424 and 426 of transmitted laser light and reflected laser light, respectively, with a phase shift 428 between the two waveforms. The phase shift may be detected by a detector at multiple time points 422.

A range for indirect time of flight (TOF) systems may be expressed as:

d=c*ΔΦ/4πf_{AM} (3)

A resolution may be expressed as:

ΔΦ=4πf_{AM}*Δd/C (4)

Using modulated transmit laser beam, a phase change of the return beam compared with the transmitted waveform. Overcoming the resolution challenge of direct time of flight (TOF), an example indirect time of flight (TOF) system with a 2 GHz modulation frequency may detect a feature size of 10 micrometers with a resolution of 0.046 deg and a feature size of 1 mm with a resolution of 4.6 deg.

As discussed herein, time of flight (TOF) information may be obtained from a phase difference between transmitted and received laser waveforms, which are modulated. A variety of phase detection systems and techniques may be used to determine the phase difference. Two example approaches are described below.

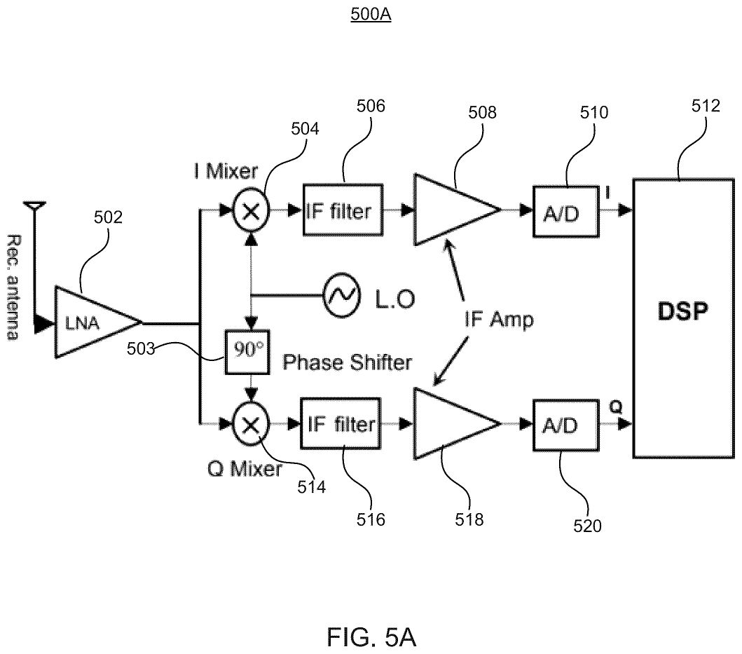

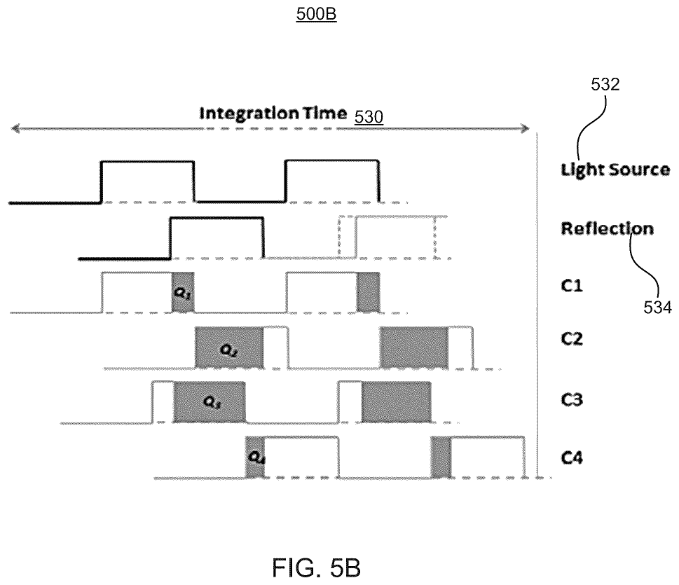

FIG. 5A illustrates a schematic diagram of a device for quadrature analog front end detection, according to an example. Diagram 500A shows a low noise amplifier (LNA) 502 receiving an input signal and providing to two mixers (I mixer 504 and Q mixer 514). The mixers receive a local oscillator signal for down-converting the received signal with the Q mixer 514 receiving a 90 degree phase shifted (through phase shifter 503) version of the local oscillator signal. The down-converted signals with 90-degree phase shift are filtered through respective intermediate frequency (IF) filters 506 and 516, amplified through respective IF amplifiers 508 and 518, and digitized by analog-digital converters (ADCs) 510 and 520. The digitized signals are then processed by a digital signal processor (DSP) 512.

Quadrature detection uses two detector channels separated by 90 degrees. One is the called the real channel. The real channel may produce a cosine wave. The digital signal processor (DSP) 512 may perform a Fourier transform to process the signals. The Fourier transform of the signal from the real channel may produce a real and an imaginary spectrum. The real spectrum corresponds to the cosine component. The imaginary spectrum corresponds to the sine component. These may be labeled the real spectrum of the real channel (real of the real) and the imaginary spectrum of the real channel (imaginary of the real). The second quadrature channel is called the imaginary channel. It is oriented 90 degrees from the real channel. This produces a signal that corresponds to a sine wave. The Fourier transform of the imaginary channel also produces a real and imaginary spectrum. These are labeled the real spectrum of the imaginary channel, and the imaginary spectrum of the imaginary channel. The spectra from the real and imaginary channel may be combined to produce a single set of quadrature detected real and imaginary spectra.

FIG. 5B illustrates waveform diagram for continuous wave quadrature detection. Diagram 500B shows waveforms of transmitted laser beam 532, reflected laser beam 534, and quadrature detection channels (charges) C1, C2, C3, C4 over integration time 530.

As shown in the diagram, the phase shift between the transmitted laser beam waveform 532 and the reflected laser beam waveform 534 corresponds to charge Q1 in the first channel of quadrature detection, where the waveform's timing coincides with that of the transmitted laser beam waveform 532. The second channel, C2, is 180-degree phase shifted version of C1 and the second charge, Q2 is complementary to Q1. The third channel, C3, is 90-degree phase shifted version of C1. Q3 is the charge that begins with the pulse of the reflected laser beam 534 and ends with the pulse of C3. The fourth channel, C4, is 270-degree phase shifted version of C1 (or 180-degree phase shifted version of C3) and Q4 begins with the pulse of C4 and ends with the pulse of the reflected laser beam 534. The terms (Q3−Q4) and (Q1−Q2) reduce the effect of constant offset from the measurements. In the provided example system, the phase difference, φ, between the transmitted laser beam and the reflected laser beam may be expressed as:

φ=arctan(Q3−Q4)/(Q1−Q2) (5)

While modulation of transmitted laser beam is shown as sinusoidal or pulsed in the illustrative examples herein, other modulation waveforms may also be used. Furthermore, the modulation frequency may be mixed or chopped.

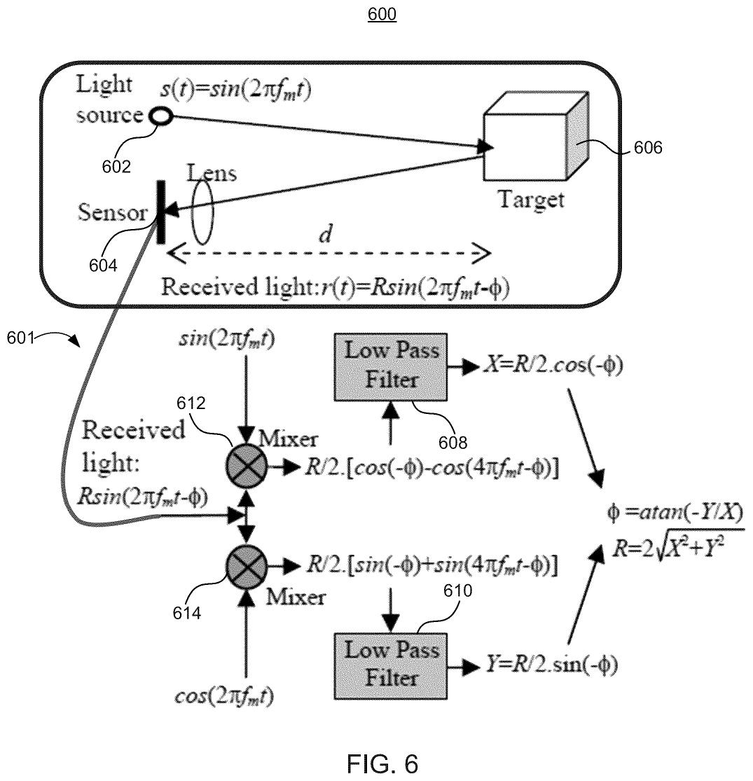

FIG. 6 illustrates a system diagram for analog homodyne phase detection, according to an example. Diagram 600 shows an analog homodyne phase detection based eye tracking system that includes a light source 602, target object 606, and sensor 604. The system also includes a phase detection block 601 with mixers 612 and 614 and low pass filters 608 and 610.

In an analog homodyne phase detection system, the mixers use the same frequency as the transmitted waveform for down-converting. The mixers 612 and 614 are used to extract phase and amplitude. A sum frequency (2fₘ) is blocked by the low pass filters 608, 610.

In an example operation, the light source 602 (e.g., a laser diode) may transmit a laser beam modulated by a sinusoidal signal sin(2πf_{M}t). The received (reflected) beam at the sensor 604 may be characterized by R sin(2πf_{M}t−φ), where φ is the phase difference between the transmitted beam waveform and the received beam waveform. The received signal may be down-converted by two mixers. The first mixer 612 may receive as local oscillator frequency sin(2πf_{M}t), whereas the second mixer 614 may receive as local oscillator frequency cos(2πf_{M}t) (90-degree shifted). Outputs of the mixers may be characterized as R/2[cos(−φ)−cos(4πf_{M}t−φ)] for the mixer 612 and R/2[sin(−φ)−sin(4πf_{M}t−φ)] for the mixer 614. As mentioned herein, the low pass filters may block the sum frequency. Thus, an output of the low pass filter 608 may be expressed as

X=R/2 cos(−φ) (6)

An output of the low pass filter 610 may be expressed as

Y=R/2 sin(−φ) (7)

From the outputs of the low pass filters, the phase difference and the amplitude of the received signal may be expressed as

φ=atan(−Y/X) (8)

R=2(X²+Y²)^{1/2} (9)

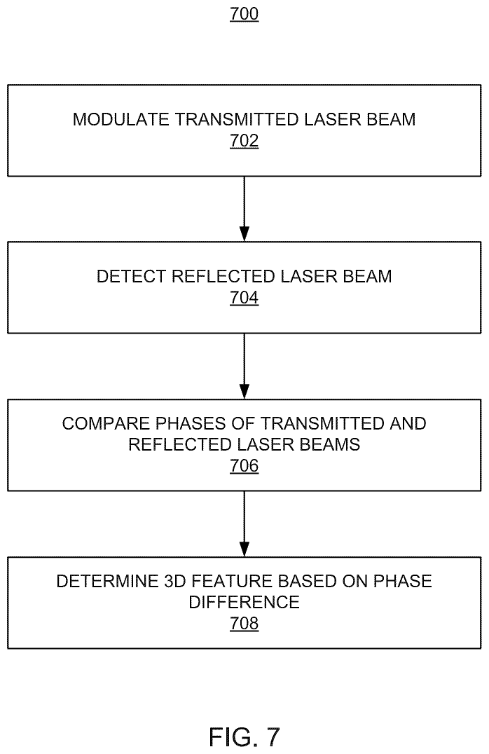

FIG. 7 illustrates a flow diagram of a method for three-dimensional (3D) sensing for eye tracking using indirect time of flight (TOF) information, according to some examples. The method 700 is provided by way of example, as there may be a variety of ways to carry out the method described herein. Although the method 700 is primarily described as being performed by the components of FIG. 4A, the method 700 may be executed or otherwise performed by one or more processing components of another system or a combination of systems. Each block shown in FIG. 7 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 702, a modulated laser beam may be transmitted to the eye by a laser source. The modulation may be sinusoidal (e.g., sin(2πf_{M}t) or pulsed (ON/OFF keyed)). The transmitted laser beam may be reflected from a surface of the eye and return as reflected laser beam. A phase of the returned laser beam may change based on a distance between the laser source, the eye, and the detector.

At block 704, the reflected laser beam may be detected by a detector. Both the laser source and the detector may be on a frame of a near-eye display device, thus approximately same distance to and from the eye. A phase of the detected laser beam, φ, may be related to a distance, d, to the eye as

d=(cΔφ)/(4πf_{M}) (10)

At block 706, the phases of the transmitted and reflected laser beams may be compared to determine the phase difference using quadrature analog front end detection (when pulsed modulation is used) or analog homodyne phase detection (when sinusoidal modulation is used).

At block 708, the distance to the eye, and thereby the three-dimensional (3D) feature of the eye may be computed based on the detected phase difference. In some examples, the phase difference may be determined by coupling the transmitted sinusoidal waveform (e.g., sin(2πfm)) to an input of a first mixer, coupling a reflected sinusoidal waveform to a second input of the first mixer, coupling the transmitted sinusoidal waveform to the input of a 90-degree phase shifter, coupling the output of the phase shifter (e.g., cos(2πfm)) to an input of a second mixer, coupling the reflected sinusoidal waveform to a second input of the second mixer, coupling the output of each mixer to the input of an associated low pass filter (LPF), and determining the phase difference based on the output from both low pass filters (LPFs).

According to examples, a method of making an eye tracking system using indirect time of flight (TOF) information is described herein. A system of making the eye tracking system using indirect time of flight (TOF) information is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An eye tracking system, comprising:
a light source to transmit a light beam onto an eye, wherein the transmitted light beam is modulated;
a detector to detect a reflected light beam from a surface of the eye;
a phase detection block to determine a phase difference between the transmitted light beam and the detected light beam; and
a controller communicatively coupled to the light source, the detector, and the phase detection block, the controller to:
coordinate a timing of transmission and detection between the light source and the detector; and
determine a distance to the surface of the eye based on the phase difference.

2. The eye tracking system of claim 1, wherein the light source is a laser source.

3. The eye tracking system of claim 1, wherein
the transmitted light beam is modulated using a pulsed signal, and
the phase detection block is a quadrature analog front end detection block.

4. The eye tracking system of claim 3, wherein the phase detection block is to detect a phase difference using:
φ=arctan(Q3−Q4)/(Q1−Q2), where
Q1, Q2, Q3, and Q4 represent respective charges for quadrature detection channels C1, C2, C3, and C4 over an integration time.

5. The eye tracking system of claim 1, wherein
the transmitted light beam is modulated using a sinusoidal signal, and
the phase detection block is an analog homodyne phase detection block.

6. The eye tracking system of claim 5, wherein the phase detection block comprises:
two 90-degree phase-shifted mixers to extract phase and amplitude; and
a low pass filter for each mixer to block a sum frequency.

7. The eye tracking system of claim 1, further comprising:
an imaging lens to focus the reflected light beam onto the detector.

8. The eye tracking system of claim 1, wherein the transmitted light beam is modulated using a signal with a frequency in a range from about 2 GHz to about 5 GHz.

9. A near-eye display device, comprising:
a display to provide an image on an eye; and
an eye tracking system comprising:
a laser source to transmit a modulated laser beam onto the eye;
a detector to detect a reflected laser beam from a surface of the eye;
a phase detection block to determine a phase difference between the transmitted laser beam and the detected laser beam; and
a controller communicatively coupled to the laser source, the detector, and the phase detection block, the controller to:
coordinate a timing of transmission and detection between the laser source and the detector; and
determine a distance to the surface of the eye based on the phase difference.

10. The near-eye display device of claim 9, wherein the phase detection block is to determine the phase difference between the transmitted laser beam and the detected laser beam through quadrature analog front end detection.

11. The near-eye display device of claim 10, wherein the phase detection block is to detect a phase difference using:
φ=arctan(Q3−Q4)/(Q1−Q2), where
Q1, Q2, Q3, and Q4 represent respective charges for quadrature detection channels C1, C2, C3, and C4 over an integration time.

12. The near-eye display device of claim 9, wherein the phase detection block is to determine the phase difference between the transmitted laser beam and the detected laser beam through analog homodyne phase detection.

13. The near-eye display device of claim 12, wherein the phase detection block comprises:
two 90-degree phase-shifted mixers to extract phase and amplitude; and
a low pass filter for each mixer to block a sum frequency.

14. The near-eye display device of claim 9, further comprising:
an imaging lens to focus the reflected light beam onto the detector.

15. A method for eye tracking in a near-eye display device, the method comprising:
modulating a laser beam;
transmitting the modulated laser beam onto an eye;
detecting a reflected laser beam from a surface of the eye;
is determining a phase difference between the transmitted laser beam and the detected laser beam; and
determining a distance to the surface of the eye based on the phase difference.

16. The method of claim 15, further comprising:
sensing a three-dimensional (3D) feature of the eye based on the determined distance.

17. The method of claim 15, wherein
modulating the laser beam comprises:
modulating the laser beam with a pulsed signal; and
determining the phase difference between the transmitted laser beam and the detected laser beam comprises:
employing a quadrature analog front end detection technique.

18. The method of claim 17, wherein determining the phase difference between the transmitted laser beam and the detected laser beam comprises:
detecting the phase difference using:
φ=arctan(Q3−Q4)/(Q1−Q2), where
Q1, Q2, Q3, and Q4 represent respective charges for quadrature detection channels C1, C2, C3, and C4 over an integration time.

19. The method of claim 15, wherein
modulating the laser beam comprises:
modulating the laser beam with a sinusoidal signal; and
determining the phase difference between the transmitted laser beam and the detected laser beam comprises:
employing an analog homodyne phase detection technique.

20. The method of claim 19, wherein determining the phase difference between the transmitted laser beam and the detected laser beam comprises:
extracting phase and amplitude using two 90-degree phase-shifted mixers; and
blocking a sum frequency using a low pass filter for each mixer.
